(19) United States
(12) Patent Application Publication
(10) Pub. No.: US 2026/0244513 A1
(43) Pub. Date: Aug. 20, 2026

(54) APPLICATION PROGRAM

(71) Applicant: TENCENT TECHNOLOGY (SHENZHEN) COMPANY LIMITED, Shenzhen (CN)

(72) Inventors: Fengmian GUO, Shenzhen (CN); Canhui HUANG, Shenzhen (CN)

(73) Assignee: TENCENT TECHNOLOGY (SHENZHEN) COMPANY LIMITED, Shenzhen (CN)

(21) Appl. No.: 19/641,254

(22) Filed: Apr. 7, 2026

Related U.S. Application Data
(63) Continuation of application No. PCT/CN2024/137074, filed on Dec. 5, 2024.

(30) Foreign Application Priority Data
Jan. 4, 2024 (CN) 202410011248.1

(51) Int. Cl. G06F 9/50; G06F 9/445

(52) U.S. Cl. CPC G06F 9/5077; G06F 9/44505; G06F 9/44526

(57) ABSTRACT

In an application program execution method, a first application development framework, an application program, and a second application development framework are determined based on a user operation. A first resource bundle of the application program is obtained, the first resource bundle indicating first application resources usable by the application program executed under the first application development framework. The first resource bundle is adjusted based on application program resource condition information of the second application development framework to obtain a second resource bundle of the application program, the second resource bundle indicating second application resources usable by the application program executed under the second application development framework. The application program is executed, by processing circuitry, under the second application development framework based on the second resource bundle. Apparatus and non-transitory computer-readable storage medium counterparts are also described.

### RELATED APPLICATIONS

The present application is a continuation of International Application No. PCT/CN2024/137074, filed on Dec. 5, 2024, which claims priority to Chinese Patent Application No. 202410011248.1, filed on Jan. 4, 2024, and entitled “APPLICATION PROGRAM PROCESSING METHOD AND APPARATUS, COMPUTER DEVICE, AND STORAGE MEDIUM.” The entire disclosures of the prior applications are hereby incorporated by reference.

### FIELD OF THE TECHNOLOGY

This disclosure relates to the field of computer technologies, including application program execution methods and apparatuses, computer devices, storage mediums, and computer program products.

### BACKGROUND

In the field of cross-platform application development, for a general-purpose application program in an industry, such as a powerful and general-purpose code editor, the code editor often has a strong dependency on an application development framework, causing that services using other application development frameworks cannot directly utilize the code editor. In some applications, in order to enable the code editor to adapt to other application development frameworks, a simplified version of the code editor with reduced capabilities may be available, or a new and complex editor tool may be developed based on the target application development framework through a large amount of development work.

However, the simplified version of the editor may offer less functions, may not be well-supported by a plug-in marketplace, and may rely more on the underlying system and file capabilities. A use experience of the newly developed editor may be inconsistent with that of the general-purpose editor in the industry.

### SUMMARY

This disclosure provides application program processing methods and apparatuses, computer devices, non-transitory computer-readable storage mediums, and computer program products.

According to an aspect, this disclosure provides an application program execution method. In the method, a first application development framework, an application program, and a second application development framework are determined based on a user operation. In the method, a first resource bundle of the application program is obtained, the first resource bundle indicating first application resources usable by the application program executed under the first application development framework. In the method, the first resource bundle is adjusted based on application program resource condition information of the second application development framework to obtain a second resource bundle of the application program, the second resource bundle indicating second application resources usable by the application program executed under the second application development framework. In the method, the application program is executed by processing circuitry under the second application development framework based on the second resource bundle.

According to an aspect, this disclosure provides an application program execution apparatus that includes processing circuitry configured to determine a first application development framework, an application program, and a second application development framework based on a user operation. The processing circuitry is configured to obtain a first resource bundle of the application program, the first resource bundle indicating first application resources usable by the application program executed under the first application development framework. The processing circuitry is configured to adjust the first resource bundle based on application program resource condition information of the second application development framework to obtain a second resource bundle of the application program, the second resource bundle indicating second application resources usable by the application program executed under the second application development framework. The processing circuitry is configured to execute the application program under the second application development framework based on the second resource bundle.

According to an aspect, this disclosure provides a non-transitory computer-readable storage medium storing instructions, which when executed by a processor, cause the processor to perform an application program execution method. In the method, a first application development framework, an application program, and a second application development framework are determined based on a user operation. In the method, a first resource bundle of the application program is obtained, the first resource bundle indicating first application resources usable by the application program executed under the first application development framework. In the method, the first resource bundle is adjusted based on application program resource condition information of the second application development framework to obtain a second resource bundle of the application program, the second resource bundle indicating second application resources usable by the application program executed under the second application development framework. In the method, the application program is executed under the second application development framework based on the second resource bundle.

According to an aspect, this disclosure provides an application program processing method, performed by a computer device and including: determining a first application development framework, an application program, and a second application development framework; acquiring a first resource bundle of the application program, the first resource bundle being suitable for the first application development framework and including application resources used by the application program during a use process thereof; determining an application program resource condition matched with the second application development framework and adjusting the first resource bundle according to the application program resource condition to obtain a second resource bundle of the application program, the second resource bundle being suitable for the second application development framework; and running the application program in the second application development framework by way of the second resource bundle.

According to another aspect, this disclosure further provides an application program processing apparatus, including: a determination module, configured to determine a first application development framework, an application program, and a second application development framework; an acquisition module, configured to acquire a first resource bundle of the application program, the first resource bundle being suitable for the first application development framework and including application resources used by the application program during a use process thereof; an adjustment module, configured to determine an application program resource condition matched with the second application development framework and adjust the first resource bundle according to the application program resource condition to obtain a second resource bundle of the application program, the second resource bundle being suitable for the second application development framework; and a running module, configured to run the application program in the second application development framework by way of the second resource bundle.

According to another aspect, this disclosure further provides a computer device, including a memory (e.g., including a non-transitory computer-readable storage medium) and processing circuitry (e.g., including a processor), the memory having a computer program stored therein, and the processor executing the computer program to implement the application program processing method described above.

According to another aspect, this disclosure further provides a non-transitory computer-readable storage medium, having a computer program stored therein, the computer program being executed by processing circuitry (e.g., including a processor) to implement the application program processing method described above.

According to another aspect, this disclosure further provides a computer program product, including a computer program, the computer program being executed by processing circuitry (e.g., including a processor) to implement the application program processing method described above.

Details of one or more aspects of this disclosure will be provided in the following drawings and descriptions. Other features, purposes and advantages of this disclosure in view of the description, drawings, and claims are within the scope of this disclosure.

### BRIEF DESCRIPTION OF THE DRAWINGS

To describe technical solutions in this disclosure, the following briefly describes accompanying drawings for describing one or more aspects of this disclosure. The accompanying drawings in the following descriptions show non-limiting examples of this disclosure, and a person skilled in the art may still derive other drawings from disclosed accompanying drawings.

FIG. 1 is a diagram of an application environment of an application program processing method according to an aspect.

FIG. 2 is a schematic flowchart of an application program processing method according to an aspect.

FIG. 3 is a diagram of an example of an operation interface for application program processing in an aspect.

FIG. 4 is a schematic flowchart of a resource adjustment method for a first resource bundle in an aspect.

FIG. 5 is a schematic flowchart of a method for adjusting resources of a startup resource type in an aspect.

FIG. 6 is a diagram of an example of resources of a first sub-environment type in an application development framework in an aspect.

FIG. 7 is a schematic flowchart of a method for adjusting resources of a second sub-communication type in an aspect.

FIG. 8 is a diagram of an example of an application mode of a second resource bundle in an aspect.

FIG. 9 is a diagram of an example of an application mode of a second resource bundle in another aspect.

FIG. 10 is a diagram of an example of an adjustment mode of an operating environment module in an aspect.

FIG. 11 is a structural diagram of an example of a general inter-process communication module in an aspect.

FIG. 12 is a structural block diagram of an application program processing apparatus in an aspect.

FIG. 13 is an internal structural diagram of a computer device executing an application program processing method in an aspect.

### DETAILED DESCRIPTION

The technical solutions in one or more aspects of this disclosure are described in the following with reference to the accompanying drawings in this disclosure. The described aspects are some rather than all of the aspects of this disclosure. Other aspects obtained by a person skilled in the art based on the aspects of this disclosure shall fall within the scope of this disclosure.

Descriptions of terms in this disclosure are provided as examples only and are not intended to limit the scope of the disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

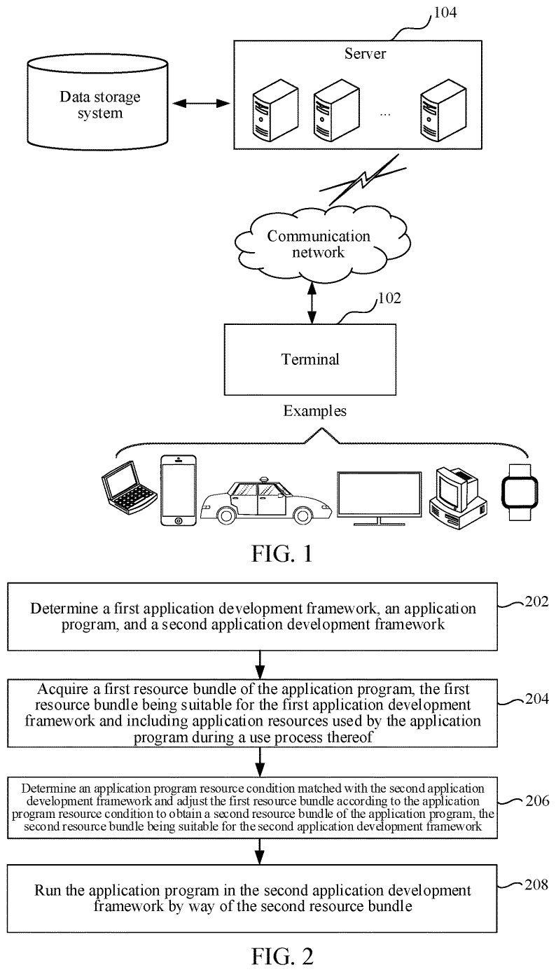

An application program processing method (e.g., an application program execution method) provided in aspects of this disclosure may be applied to an application environment shown in FIG. 1. A terminal 102 communicates with a server 104 through a network. A data storage system may store data that the server 104 processes. The data storage system may be integrated on the server 104, or may be placed on a cloud or any other web server. An adjustment function item for an application program is displayed in an interface of a terminal. In response to a trigger operation on the adjustment function item, an application program processing request for the application program is transmitted to a server. The application program processing request is configured to request the server to adjust a first resource bundle of the application program to obtain a second resource bundle suitable for a second application development framework. The server receives and parses the application program processing request; determines a first application development framework, an application program, and a second application development framework; acquires a first resource bundle of the application program, the first resource bundle being suitable for the first application development framework and including application resources used by the application program during a use process thereof; determines an application program resource condition matched with the second application development framework and adjusts the first resource bundle according to the application program resource condition to obtain a second resource bundle of the application program, the second resource bundle being suitable for the second application development framework; and runs the application program in the second application development framework by way of the second resource bundle. The terminal 102 may correspond to, but is not limited to, various personal computers, laptops, smart phones, tablets, Internet of Things (IoT) devices, and portable wearable devices. The IoT devices may include smart speakers, smart TVs, smart air conditioners, smart vehicle-mounted devices, or the like. The portable wearable device may be a smart watch, a smart band, a head-mounted device, and the like. The server 104 may be implemented using an independent server or a server cluster that includes multiple servers.

In some aspects, as shown in FIG. 2, an application program processing method (e.g., an application program execution method) is provided. The method is described by taking an example in which the method is applied to a computer device (the computer device may be the terminal or the server in FIG. 1). The method includes the following operation 202 to operation 208.

Operation 202: Determine a first application development framework, an application program, and a second application development framework. For example, a first application development framework, an application program, and a second application development framework are determined based on a user operation.

The determining a first application development framework, an application program, and a second application development framework may include determining an identifier of the first application development framework, an identifier of the application program, and an identifier of the second application development framework. The identifier may be a name or a character string conforming to a prescribed format.

In some implementations, an application development framework refers to an application development framework that implements cross-platform application development. In some examples, an application development framework is a tool or framework that allows a developer to build cross-platform application programs using a unified code base or language. The application development framework in this disclosure may refer to a cross-platform application development framework based on Web technologies. For example, the application development framework may be a framework uses Web front-end technologies, such as HyperText Markup Language (HTML), Cascading Style Sheets (CSS), and JavaScript (a scripting programming language, abbreviated as JS), to build application programs. Different application development frameworks have different implementation principles. For ease of description, the application development framework on which an application program to be processed depends is referred to as a first application development framework, and the application development framework to which a processed application program is applicable is referred to as a second application development framework. An application program developed using a first application development framework is an application program that depends on the first application development framework. An application program that depends on the first application development framework satisfies an application program resource condition matched (e.g., complies) with the first application development framework, and needs to run (e.g., execute) in an environment of the first application development framework. An implementation principle of the first application development framework is different from that of the second application development framework. An application program that depends on the first application development framework is not applicable to the second application development framework before the application program being processed for execution according to one or more examples in this disclosure. In some examples, one or more application development frameworks described herein may include an Electron framework, an NW.js framework, a QT framework, and the like. The first application development framework may be a first desktop application development framework. The application program may be a desktop application program. The second application development framework may be a second desktop application development framework.

In some aspects, the first application development framework, the application program, and the second application development framework may be determined in response to a user input operation.

In an example, different implementation principles of different application development frameworks will be described by taking an example in which the first application development framework is an Electron framework and the second application development framework is an NW.js framework. Electron is an application development framework based on Node.js (a JavaScript interpreter running on a server side, a JavaScript operating environment based on a Chrome V8 engine) and Chromium (a browser kernel). An implementation principle thereof is that Chromium is invoked as a separate component, and a working mechanism thereof is more like a runtime of Node.js. Cross-platform desktop applications may be created using HTML, CSS, and JavaScript. NW.js is also a framework based on Node.js, but different from the Electron framework, an implementation principle of the NW.js framework is that Node.js is integrated into Chromium, and a kernel of Chromium is modified, which is equivalent to a browser with Node capabilities. NW.js allows application programs to be written using JavaScript, HTML, and CSS, and provides integration with an operating system.

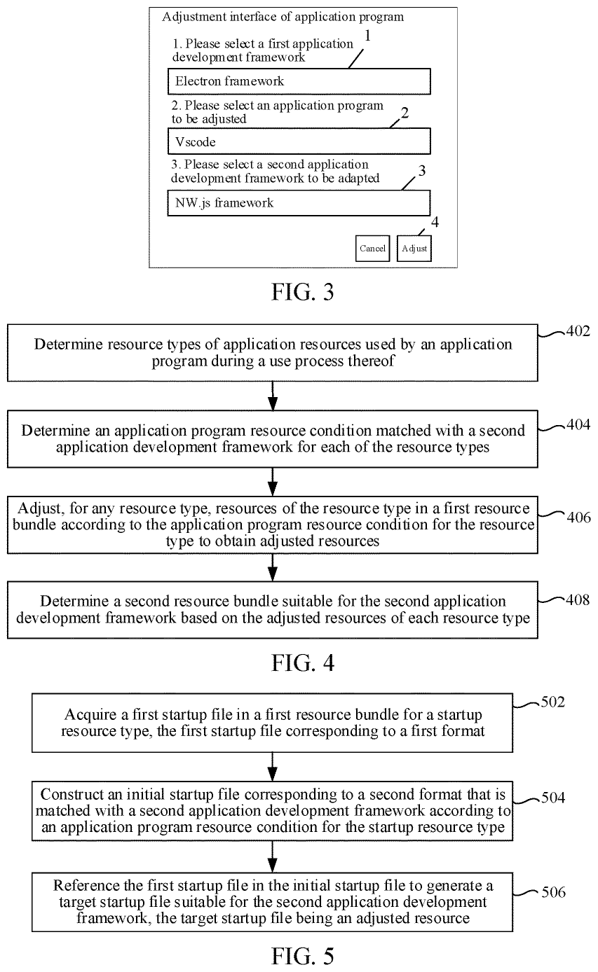

In some implementations, a mode in which a computer device determines an application program to be processed may be determined based on an operable input interface, or reading from a preset configuration file. In an example, as shown in FIG. 3, FIG. 3 is a diagram of an example of an operation interface for application program processing in an aspect. The visualized input interface shown in the figure includes a function item indicated by numeral 1 for selecting a first application development framework, a function item indicated by numeral 2 for selecting an application program that is developed based on the first application development framework and needs to be adjusted, a function item indicated by numeral 3 for selecting a second application development framework to which an adjusted application program needs to be adapted, and a determination function item indicated by numeral 4 for executing application program processing. The application program that is developed based on the first application development framework and needs to be processed is acquired through the function items indicated by numerals 1 and 2, the second application development framework to be applied is determined through the function item indicated by numeral 3, and based on a trigger operation on the determination function item, the computer device determines the application program that is developed based on the first application development framework and needs to be processed in this application program processing.

Operation 204: Acquire a first resource bundle of the application program, the first resource bundle being suitable for the first application development framework and including application resources used by the application program during a use process thereof. For example, a first resource bundle of the application program is obtained, the first resource bundle indicating first application resources usable by the application program executed under the first application development framework.

The acquiring a first resource bundle of the application program may include acquiring a first resource bundle corresponding to the identifier of the application program. After the first application development framework and the application program are determined, the first resource bundle of the application program that is suitable for the first application development framework can be specified. The first resource bundle corresponding to the identifier of the application program may be a first resource bundle stored in a storage location corresponding to the identifier of the application program, or a first resource bundle whose resource bundle identifier includes the identifier of the application program. The resource bundle identifier is configured to uniquely identify the first resource bundle.

In some implementations, after determining the application program to be processed, the computer device acquires a first resource bundle of the application program to be processed. The first resource bundle is a resource bundle used by the application program to be processed when running in an environment that depends on the first application development framework. The first resource bundle includes all application resources used by the application program to be processed during an entire lifecycle of the application program. The application program processing performed by the computer device on the application program to be processed may include an adjustment operation on the application resources included in the first resource bundle, so that an adjusted first resource bundle can be suitable for the second application development framework. In addition, the application resources included in the first resource bundle may be viewed in a file directory mode.

The first resource bundle being suitable for the first application development framework means that the application program can be run in the environment of the first application development framework through the first resource bundle. At least a part of the application resources, which are included in the first resource bundle and used by the application program during a use process thereof, would be used with the support of the environment of the first application development framework. For example, invoking or utilizing a portion or all of the application resources may be based on reading of a specific file adapted to the first application development framework, or reading of data in a specific format adapted to the first application development framework, or invocation of an interface adapted to the first application development framework, or the like.

The application resources in the first resource bundle are described. In some aspects, the application resources in the first resource bundle include at least one of: startup resources used by the application program to be processed during a startup phase thereof, operating environment resources used by the application program to be processed during an operating phase thereof, or communication resources used by the application program to be processed during the operating phase thereof. For example, the first application resources in the first resource bundle may include at least one of (i) startup resources usable during a startup phase of execution of the application program, (ii) operating environment resources usable during an operating phase of the execution of the application program, or (iii) communication resources usable during the operating phase of the execution of the application program.

In some implementations, the application program to be processed that depends on the environment of the first application development framework requires different application resources at different phases during a use process thereof. For example, corresponding startup resources are required during a startup phase of a lifecycle, and corresponding operating environment resources and communication resources capable of interacting with an operating system are required during an operating phase of the lifecycle.

Operation 206: Determine an application program resource condition matched with (or complies with) the second application development framework and adjust the first resource bundle according to the application program resource condition to obtain a second resource bundle of the application program, the second resource bundle being suitable for the second application development framework. For example, the first resource bundle is adjusted based on application program resource condition information of the second application development framework to obtain a second resource bundle of the application program, the second resource bundle indicating second application resources usable by the application program executed under the second application development framework.

In some implementations, the computer device performs an adjustment operation on the application resources included in the first resource bundle, and the adjustment operations is based on application program resource condition information matched with (or complies with) the second application development framework. The application program resource condition matched with the second application development framework refers to a condition that is satisfied by application resources of an application program that can run (e.g., executed) in an environment of the second application development framework. For the first resource bundle, the computer device determines an application program resource condition matched with the second application development framework, and adjusts the first resource bundle according to the application program resource condition to obtain a second resource bundle of the application program. The second resource bundle is suitable for the second application development framework. Since the first resource bundle includes startup resources, operating environment resources, and communication resources, in some aspects, the computer device may adjust the startup resources, the operating environment resources, and the communication resources in the first resource bundle according to an application program resource condition matched with the second application development framework, to obtain a second resource bundle suitable for the second application development framework.

In some implementations, since the application resources in a resource bundle may exist in at least one file format, the resource bundle may be regarded as a folder. The folder may include sub-folders and files in a plurality of different file formats. In this case, the adjustment performed by the computer device on the first resource bundle may include adjusting, according to a target order, folders or files in the folders according to an application program resource condition matched with the second application development framework, for example, performing adjustment on each folder in a file-by-file mode. For example, the computer device may read content in a file or a folder. If the read content is related to the first application development framework, an application program resource condition configured to the read content in the second application development framework is acquired, and the read content is adjusted according to the condition. In addition, classification may also be performed based on characteristics of the application resources at different phases during a use phase thereof. For example, resource types of the application resources may include a startup resource type, a communication resource type, and an environment resource type. In this case, based on the resource types, the computer device may respectively adjust the application resources in the first resource bundle according to the resource types, to obtain adjusted application resources corresponding to each resource type. The computer device integrates the adjusted application resources corresponding to each resource type as a second resource bundle suitable for the second application development framework.

Operation 208: Run the application program in the second application development framework by way of the second resource bundle. For example, the application program is executed by processing circuitry under the second application development framework based on the second resource bundle.

In some implementations, an adjusted second resource bundle of the application program to be processed is suitable for the second application development framework. That is, the computer device can run, by way of the second resource bundle in the second application development framework, the application program obtained after performing application program processing on the application program to be processed. For the same application program, there are two resource bundles, namely, a first resource bundle suitable for the first application development framework and a second resource bundle suitable for the second application development framework. The computer device performs application program processing on the application program corresponding to the first resource bundle, to obtain the application program corresponding to the second resource bundle. A mode of invoking the second resource bundle in the environment of the second application development framework may be directly executing the application program in a form of a desktop application under the second application development framework based on the second resource bundle. Running the application program corresponding to the second resource bundle in the environment of the second application development framework means using the second resource bundle as an installation package to be directly installed and launched on the computer device. Alternatively, the second resource bundle may be integrated with other application programs that depend on the second application development framework. For example, the second resource bundle is used as a plug-in, and is invoked in a form of a plug-in in a target application program running in the second application development framework.

In the above application program processing method, for the first resource bundle of the application program that depends on the first application development framework, adjustment is performed according to an application program resource condition matched with the second application development framework, to obtain a second resource bundle of the application program suitable for the second application development framework. In this way, the dependency of the first resource bundle on the first application development framework can be removed or reduced, and a second resource bundle capable of adapting to the second application development framework can be obtained. Then, the application program is run in the second application development framework by way of the second resource bundle. In this way, an application depending on the second application development framework can integrate and use functions of the application program, so as to meet editing functions of a desktop application based on the NW.js framework. At the same time, the cost investment of re-developing an application program suitable for the second application development framework can be avoided, and a use experience of an adjusted application program that depends on the second application development framework can be aligned with a use experience of the application program that depends on the first application development framework before adjustment.

In some aspects, as shown in FIG. 4, the computer device determines an application program resource condition matched with the second application development framework, adjusts the first resource bundle according to the application program resource condition to obtain a second resource bundle of the application program, the second resource bundle being suitable for the second application development framework, including the following operation 402 to operation 408.

Operation 402: Determine resource types of application resources used by an application program during a use process thereof.

In some implementations, when an application program runs in an environment provided by a first application development framework, application resources used by the application program during an entire lifecycle of the application program may be classified according to resource types. The resource types may at least include a startup resource type, a communication resource type, and an environment resource type. The startup resource type refers to a type of application resources used by the application program when starting up depending on the application development framework during a startup phase of a lifecycle. The environment resource type refers to a type of operating environment resources required by the application program when running during an operating phase of a lifecycle. The communication resource type refers to a type of application resources used by the application program when communicating with an operating system depending on the application development framework during an operating phase of a lifecycle. For each resource type, the first resource bundle includes application resources matched with the resource type. For the application program to be processed, the computer device determines resource types of application resources used by the application program at each phase of a lifecycle. For example, a resource type of application resources used by the application program to be processed during a startup phase is a startup resource type.

Operation 404: Determine an application program resource condition matched with a second application development framework for each of the resource types.

In some implementations, for each resource type, an application program developed depending on the second application development framework also includes application resources matched with the resource type. When performing a processing operation on the application program to be processed, the computer device first determines, for each resource type, an application program resource condition of the resource type matched with the second application development framework. To be matched with the resource type, the computer device determines an application program resource condition matched with the resource type in the second application development framework. The application program resource condition is configured to indicate an adjustment direction for application resources of the resource type in the first resource bundle, so that adjusted application resources corresponding to the resource type are suitable for the second application development framework.

In an example, taking a resource type being a startup resource type as an example, an application program resource condition matched with the startup resource type in an application development framework may be a requirement on a format of a startup entry file as a startup resource during a startup phase. Formats of startup entries corresponding to different application development frameworks may be different. For example, a format of a startup entry of a startup resource matched with the startup resource type in the first application development framework is a js file. For example, an index.js file is used as a startup entry. Resource bundles of application programs developed depending on the first application development framework specify that an index.js file is included to start up normally. A format of a startup entry of a startup resource matched with the startup resource type in the second application development framework is an html file. For example, an index.html file is used as a startup entry. Resource bundles of application programs developed depending on the second application development framework specify that an index.html file is included to start up normally. For the startup resource type, an application program resource condition matched with the second application development framework specifies that a startup file is an index.html file.

Operation 406: Adjust, for any resource type, resources of the resource type in a first resource bundle according to the application program resource condition for the resource type to obtain adjusted resources. In some examples, the application program resource condition information includes, for each of resource types of the first application resources, a respective application program resource condition of the second application development framework. In some examples, the adjusting the first resource bundle includes adjusting, for each of the resource types, resources of the resource type in the first resource bundle into corresponding adjusted resources of the resource type in the second resource bundle based on the corresponding application program resource condition for the resource type.

In some implementations, for each resource type, after determining an application program resource condition for the resource type in the second application development framework, the computer device adjusts, according to the application program resource condition, resources of the resource type indicated by the application program resource condition in the first resource bundle, to obtain adjusted resources.

Following the above example, continuing to take the resource type being a startup resource type as an example, the computer device determines that the first resource bundle of the application program to be processed includes an index.js file, but does not include an index.html file required by the application program resource condition for the startup resource type in the second application development framework. Based on this, the computer device may adjust related resources in the first resource bundle, so that adjusted resources associated with the startup resource type may meet the application program resource condition for the startup resource type in the second application development framework. In this case, the computer device may create a new index.html file and integrate it with the index.js file in the first resource bundle.

Operation 408: Determine a second resource bundle suitable for the second application development framework based on the adjusted resources of each resource type.

In some implementations, after adjusting, according to resource types, resources corresponding to each resource type in the first resource bundle, the computer device may directly use an adjusted first resource bundle as a second resource bundle suitable for the second application development framework, or may add, based on the adjusted first resource bundle, other resources required by the second application development framework, and repackage them to obtain the second resource bundle. In this disclosure, specific operations on the adjusted resources include any form of operation capable of obtaining a second resource bundle suitable for the second application development framework.

In this aspect, an adjustment operation on application resources is converted into adjustment operations on resources associated with different resource types respectively. Adjustment operations on application resources associated with each resource type may be performed in a parallel mode, thereby improving resource adjustment efficiency.

In some aspects, in a case that the resource types include a startup resource type, an adjustment mode of the computer device for application resources of the startup resource type, as shown in FIG. 5, includes the following operation 502 to operation 506.

Operation 502: Acquire a first startup file in a first resource bundle for a startup resource type, the first startup file corresponding to a first format.

In some implementations, a startup resource may refer to a resource corresponding to a startup mode when an application program starts up depending on an application development framework. A resource corresponding to a startup mode is usually represented by a file in a target format. The file in the target format serves as a startup entry file of an application program developed based on a corresponding application development framework. A startup resource type in the first resource bundle is a first startup file in a first format. For example, the first format is a js format, and the first startup file is index.js.

Operation 504: Construct an initial startup file corresponding to a second format that is matched with a second application development framework according to an application program resource condition for the startup resource type. For example, an initial startup file corresponding to a second format that complies with the second application development framework is constructed based on the corresponding application program resource condition for the startup resource type.

In some implementations, to obtain a second resource bundle suitable for the second application development framework, for a startup resource type, there is an application program resource condition corresponding to the startup resource type in the second application development framework. The application program resource condition may be configured to indicate a second format of a startup file corresponding to a startup entry matched with the second application development framework. For example, the application program resource condition for the startup resource type may be an initial startup file index.html in a second format of html.

Operation 506: Reference the first startup file in the initial startup file to generate a target startup file suitable for the second application development framework, the target startup file being an adjusted resource. For example, the initial startup file is modified, based on referencing the first startup file in the initial startup file, into a second startup file in the second resource bundle for the second application development framework.

In some implementations, the computer device adds the first startup file as a referenced file to the initial startup file, to obtain a target startup file configured to the second application development framework.

In an example, taking the first application development framework being an Electron framework and the second application development framework being an NW.js framework as an example, the first startup file of the Electron framework is a file in a js format, and a startup file required by the NW.js framework is in an html format. The computer device creates a new index.html file as an initial startup file, and introduces the first startup file bundle.js in a tag <script></script> of the initial startup file. The computer device performs an introduction operation through a timeout call function setTimeout. A pseudocode of the introduction operation is shown in the following pseudocode fragment 1:

```
  {setTimeout(( ) => {//Invoke a timeout call function
    const s = document.createElement(′script′)//Create a new script element
    s.type = ′text/javascript′//Type is javascript
    const content = ′;require(″../dist/bundle.js″);’//The introduced js file is
bundle.js
    const blob=newBlob([content], [ type: ′application/javascript′ })//Create a
new blob object for indicating bundle.js
    s.src = URL.createObjectURL(blob)//Convert the Blob binary file into a
URL address that can be directly displayed by a browser
    s.defer = true
    const el = document.getElementsByTagName( ′script′) [0]//End the new
script element
  },0)
  }//end
```

The computer device may introduce the first startup file in the initial startup file based on the above pseudocode, thereby implementing resource adjustment for the startup resource type and obtaining a new startup resource matched with the NW.js framework.

In this aspect, for the startup resource type, adaptability of the startup resource in the second application development framework is achieved by adjusting the startup file.

In some aspects, the resource types include an environment resource type. The environment resource type includes a first sub-environment type and a second sub-environment type. The first sub-environment type is configured to indicate a folder of an operating environment of the application program. The second sub-environment type is configured to indicate a first compiled product used by the application program when running through the first application development framework. The first compiled product is implemented based on a general-purpose programming language. Based on this, the computer device adjusts, according to an application program resource condition for the environment resource type, resources of the environment resource type in the first resource bundle to obtain adjusted resources, including: adjusting, for the environment resource type, resources of the first sub-environment type in the first resource bundle, and adjusting resources of the second sub-environment type in the first resource bundle according to the application program resource condition for the environment resource type; and determining adjusted resources of the environment resource type based on adjusted resources of the first sub-environment type and adjusted resources of the second sub-environment type.

In some implementations, for each sub-environment type, the computer device selects, from application program resource conditions for the environment resource type, an application program resource condition for a corresponding sub-environment type, to obtain adjusted resources of the sub-environment type. The computer device integrates the adjusted resources of the sub-environment types, thereby obtaining adjusted resources of the environment resource type.

In this aspect, resources of the environment resource type are divided into resources with finer granularity. The resource adjustment for the environment resource type is converted into resource adjustment related to each sub-environment type. In this way, efficiency of resource adjustment and accuracy of resource adjustment can be improved.

In some aspects, the adjusting resources of the first sub-environment type in the first resource bundle includes: determining a first folder related to an operating environment in the first resource bundle; determining a second folder matched with the second application development framework and related to the operating environment; and deleting a folder (or one or more folders) related to the first application development framework from the first folder, and adding the second folder to the first resource bundle.

In some implementations, environment resources of the first sub-environment type are usually represented in a form of a folder. The computer device determines a first folder related to an operating environment indicated by the first sub-environment type in the first resource bundle, and simultaneously determines a second folder matched with the second application development framework and related to the operating environment. Resource adjustment is performed based on the first folder and the second folder. A specific resource adjustment operation is: deleting a folder related to the first application development framework from the first folder, and adding the second folder to the first resource bundle.

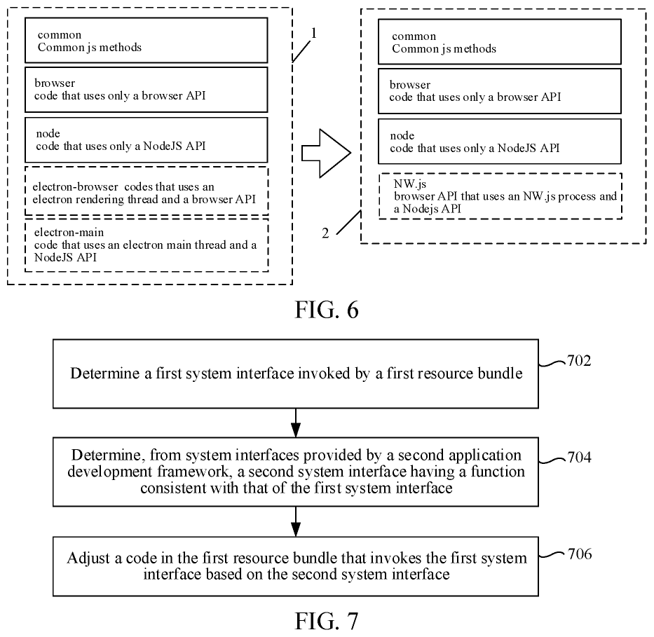

In an example, as shown in FIG. 6, FIG. 6 is a diagram of an example of resources of a first sub-environment type in an application development framework in an aspect. As shown in FIG. 6, taking the first application development framework being an Electron framework and the second application development framework being an NW.js framework as an example, numeral 1 in FIG. 6 indicates a first folder, related to an operating environment and indicated by the first sub-environment type in the Electron framework, for example, an electron-browser folder and an electron-main folder. Numeral 2 in FIG. 6 indicates a second folder, related to the operating environment and indicated by the first sub-environment type in the NW.js framework, for example, an Nw.js folder. The computer device deletes the first folder, for example, the electron-browser folder and the electron-main folder, and adds the second folder, for example, the Nw.js folder, to the first resource bundle.

In this aspect, an adjustment operation on resources of the first sub-environment type is directly converted into a replacement operation on folders and files under the folders. In this way, adjustment efficiency for resources of the first sub-environment type can be improved.

In some aspects, the computer device adjusting resources of the second sub-environment type in the first resource bundle includes: determining a first compiled product in the first resource bundle; acquiring a source code of the first compiled product, and recompiling, by a compilation component corresponding to the second application development framework, the source code to generate a second compiled product configured to the second application development framework; and replacing the first compiled product in the first resource bundle with the second compiled product.

In some implementations, resources of the second sub-environment type refer to a first compiled product used by the application program when running, and the first compiled product is implemented based on a general-purpose programming language. Since different application development frameworks have different compilation modes for resources of the second sub-environment type, an adjustment operation performed by the computer device on the resources of the second sub-environment type may include recompiling, by a compilation component matched with the second application development framework, the resources of the second sub-environment type, thereby obtaining a second compiled product configured to the second application development framework. Finally, the first compiled product in the first resource bundle is replaced with the second compiled product.

In an example, taking the first application development framework being an Electron framework, the second application development framework being an NW.js framework, and the application program depending on the first application development framework being vscode as an example, vscode, as an application program developed based on the Electron framework, is a modern lightweight code editor. The vscode editor has features such as syntax highlighting, intelligent code completion, customizable hotkeys, bracket matching, code snippets, and code comparison supporting almost mainstream programming languages, supports plug-in extension, and is optimized for web development and cloud application development. The first resource bundle of vscode includes native resources implemented based on c++ (c plus, a high-level computer programming language). A cross-platform first compiled product (at least one file in a binary form), such as vscode-ripgrep, vscode-oniguruma, vscode-textmate, is generated by a node-gyp tool configured to the Electron framework. The first compiled product is not directly applicable to (e.g., executable under) the NW.js framework. For an adjustment operation of the computer device on the first compiled product, a compilation tool nw-gyp configured to the NW.js framework is invoked to recompile a code of the first compiled product to generate a second compiled product. Herein, nw-gyp is a tool modified based on node-gyp, and is configured to build native modules running in an NW.js framework environment. Compared with node-gyp, nw-gyp adds header files of additional dependencies required by NW.js, and the like, for compilation, so that they can run in the NW.js framework environment.

In this aspect, an adjustment operation on resources of the second sub-environment type is directly converted into a recompilation operation on a source code. This can reduce complexity of the adjustment operation, directly operate the source code, help ensure non-interference of the adjustment operation, and improve efficiency of the adjustment operation and accuracy of an adjustment result.

In some aspects, the resource types include a communication resource type, the communication resource type includes a first sub-communication type and a second sub-communication type, the first sub-communication type is configured to indicate resources configured to perform cross-process communication, and the second sub-communication type is configured to indicate resources configured to invoke system interfaces related to an operating system. The computer device adjusting resources of the communication resource type in the first resource bundle includes: adjusting, for the communication resource type, resources of the first sub-communication type in the first resource bundle, and adjusting resources of the second sub-communication type in the first resource bundle according to an application program resource condition for the communication resource type; and determining adjusted resources of the communication resource type based on adjusted resources of the first sub-communication type and adjusted resources of the second sub-communication type.

In some implementations, the first sub-communication type refers to a resource type in which cross-process communication exists. Since different application development frameworks have different implementation principles, correspondingly, principles of communicating with an operating system based on different application development frameworks are also different. For ease of description, principles of different application development frameworks communicating with an operating system will be described by taking an example in which the first application development framework is an Electron framework and the second application development framework is an NW.js framework.

For the Electron framework, Chromium is used as a separate component in the Electron framework. A browser is not convenient to directly communicate with an operating system due to security issues. Therefore, a process of a desktop application supported by the Electron framework is divided into a rendering process and a main process. The rendering process is configured to perform user page rendering, and the main process is configured to manage window creation and communicating with the operating system, for example, invoking system capabilities. An application program based on the Electron framework includes one main process (e.g., one and only one in some examples) and a plurality of rendering processes. This is because the main process can invoke operating system capabilities and is responsible for managing all windows and their corresponding rendering processes.

For the NW.js framework, Node.js is integrated into Chromium in the NW.js framework, and a kernel of Chromium is modified, which is equivalent to a browser with Node capabilities. It can implement rendering and invoke system capabilities in each individual process.

There are differences in process communication between the first application development framework and the second application development framework. For example, in the first application development framework, interaction with an operating system is performed through cross-process communication, while in the second application development framework, each process independently completes interaction with the operating system. A type of resources associated with this difference in process communication is referred to as a first sub-communication type. In addition, different application development frameworks may also have differences in system interfaces provided when interacting with the operating system. A type of resources associated with these system interfaces is referred to as a second sub-communication type. The computer device performs, for resources of the first sub-communication type and resources of the second sub-communication type, an adjustment operation that satisfies an application program resource condition of a communication resource type matched with the second application development framework; and finally determines adjusted resources of the communication resource type based on adjusted resources of the first sub-communication type and adjusted resources of the second sub-communication type.

In this aspect, resources of the environment resource type are divided into resources with finer granularity. The resource adjustment for the environment resource type is converted into resource adjustment related to each sub-environment type. In this way, efficiency of resource adjustment and accuracy of resource adjustment can be improved.

In some aspects, the computer device adjusting resources of the first sub-communication type in the first resource bundle includes: determining a code of a rendering process in which cross-process communication exists in the first resource bundle, the cross-process communication being configured to implement communication between the rendering process and an operating system; and adjusting the code of the rendering process, so that a rendering process with the code adjusted directly implements communication through a context call (e.g., context invocation) when communicating with the operating system.

In some implementations, a mode in which the computer device adjusts resources of the first sub-communication type in the first resource bundle is as follows: In the first resource bundle, rendering processes involved in interacting with the operating system are implemented based on cross-process communication. For example, the rendering process interacts with the operating system by invoking a main process running in the first application development framework. In the second application development framework, however, each process can implement interaction with the operating system, and there is no mode of interacting with the operating system through cross-process communication. Therefore, the computer device first determines a rendering process in which cross-process communication exists in the first resource bundle, which may be referred to as a target rendering process, then determines a code of the target rendering process, and adjusts, in the code, a code invoking a main thread to be implemented through a context call (e.g., context invocation).

In an example, taking the first application development framework being an Electron framework and the second application development framework being an NW.js framework as an example, a rendering process withSharedProcessConnecton in which cross-process communication exists in the first resource bundle is implemented through a main process mainProcessService when interacting with the operating system. The computer device acquires the rendering process withSharedProcessConnecton, and directly modifies a code implemented through mainProcessService to be implemented through a current process call. A pseudocode of inter-process communication in the Electron framework is shown in the following pseudocode fragment 2:

```
  export class Process1 {
  // In the Electron framework, communication with the operating system is
implemented through mainProcessService
  this.sharedProcessMainChannel = mainProcessService.getChannel( );
  this.withSharedProcessConnection = this.whenSharedProcessReady( )
  .then(( ) => connect(parameter));
    }
```

In the NW.js framework, this.whenSharedProcessReady itself has the capability of interacting with the operating system. Therefore, the above pseudocode fragment 2 is directly adjusted to the following pseudocode fragment 3:

export class Process1 {
this.withSharedProcessConnection = this.whenSharedProcessReady( )
.then(( ) => connect( ‘ ‘ ,window:1 ’ ));
}

In this aspect, an adjustment operation on resources of the first sub-communication type may include an adjustment on process instances corresponding to related resources in the first resource bundle in which cross-process communication exists. In this way, adjusted process communication is performed independently by each process, thereby reducing overhead of process communication and improving efficiency of interaction with an operating system.

In some aspects, as shown in FIG. 7, the computer device adjusting resources of the second sub-communication type in the first resource bundle includes the following operation 702 to operation 706.

Operation 702: Determine a first system interface invoked (or invocable) by a first resource bundle.

In some implementations, the first system interface is an interface provided by a first application development framework for an application program to interact with an operating system. The first system interface includes at least one of: creating a system menu, a clipboard, and file system processing; a system interface related to a capability of reading from and writing to a system clipboard; a system interface related to opening a file location at a specified path; or a system interface related to a function such as using a file selection pop-up window.

In an example, taking the first application development framework being an Electron framework as an example, a first system interface provided by the Electron framework is a system interface supporting a capability of reading from and writing to a system clipboard, including writeClipboardText and readClipboardText.

Operation 704: Determine, from system interfaces provided by a second application development framework, a second system interface having a function consistent with that of the first system interface.

In some implementations, the second application development framework also provides a plurality of system interfaces for interacting with an operating system, so that an application program depending on the second application development framework can interact with the operating system. Among the system interfaces provided by the second application development framework, there is a second system interface having a function consistent with that of the first system interface. For example, a function implemented by the second system interface provided by the second application development framework is consistent with a function implemented by the first system interface provided by the first application development framework. The computer device may preset a matching relationship between the first system interface and the second system interface. Since an interface name of the first system interface and an interface name of the second system interface may be different, a matching relationship between the first system interface and the second system interface may be preset. In this way, the computer device can determine, through the matching relationship, a target second system interface having a function consistent with that of the first system interface. Creation of the matching relationship may also be implemented based on an artificial intelligence model.

In an example, taking the first application development framework being an Electron framework and the second application development framework being an NW.js framework as an example, a matching relationship between a first system interface of the Electron framework and a second system interface of the NW.js framework is preset, as shown in Table 1.

TABLE 1

| Function Name | First System Interface | Second System Interface |
|---|---|---|
| Write system clipboard writeText | writeClipboardText | nw.Clipboard.get( ).set( ) |
| Read system clipboard readText | readClipboardText | nw.Clipboard.get( ).get( ) |
| Access specified file location | showItemInFoler | nw.Shell.showItemInFoler |
| revealResourcesInOS | | |
| File selection pop-up window | dialog.showSaveDialog | saveFileDialog |

Table 1 shows that a second system interface provided by the NW framework and supporting a capability of reading from and writing to a system clipboard is nw.Clipboard. For example, a function implemented by the nw.Clipboard system interface provided by the NW framework is consistent with a function implemented by the nativeHostService.writeClipboardTex system interface provided by the Electron framework.

Operation 706: Adjust a code in the first resource bundle that invokes the first system interface based on the second system interface.

In some implementations, the computer device determines a first system interface in the first resource bundle, and adjusts a code of the first system interface according to an implementation code of a second system interface matched with the first system interface. In this way, the computer device can determine, through a matching relationship between system interfaces, a target second system interface having a function consistent with that of the first system interface, and modify the code of the first system interface to a code of the target second system interface.

Following the above example, taking implementation of a function of writing to a system clipboard, for example, writeText, as an example, a pseudocode for implementing writeText based on the Electron framework is shown in the following pseudocode fragment 4:

```
  async writeText(parameter type): Promise<void> {
  //Invoke the first system interface writeClipboardText provided by the Electron
framework to implement a write operation
  return this.nativeHostService.writeClipboardText(text, type);
  }
```

For the first system interface nativeHostService.writeClipboardText, according to the matching relationship shown in Table 1, it can be determined that a second system interface provided by the NW.js framework and matched with the first system interface is nw. Clipboard. The computer device adjusts a code fragment referencing writeClipboardText in the first resource bundle to a code fragment matched with nw. Clipboard.get( ).set( ). A pseudocode of the adjusted writeText is shown in the following pseudocode fragment 5:

```
  async writeText(parameter type): Promise<void> {
  //Invoke the second system interface nw.Clipboard.get( ).set of the NW.js
framework to implement a write operation
  nw.Clipboard.get( ).set({
      data: text,
      type:‘text’,
    })
  }
```

The computer device adjusts, based on the above pseudocode fragment 5, a code related to writeText in the first resource bundle, to obtain a writeText function suitable for the NW.js framework.

Following the above example, taking implementation of a function of reading from a system clipboard, for example, readText, as an example, a pseudocode for implementing readText based on the Electron framework is shown in the following pseudocode fragment 6:

```
  async readText(tyoe?: “clioboard Promisesstrino>
  //Invoke the first system interface readClipboardText provided by the Electron
framework to implement a read operation
    return this.nativeHostService.readClipboardText(type);
  }
```

For the first system interface readClipboardText, according to the matching relationship shown in Table 1, it can be determined that a second system interface provided by the NW.js framework and matched with the first system interface is nw. Clipboard.get( ).get( ). The computer device adjusts a code fragment referencing writeClipboardText in the first resource bundle to a code fragment matched with nw. Clipboard.get( ).get( ). A pseudocode of the adjusted readText is shown in the following pseudocode fragment 7:

```
  async readText(parameter type): Promise<void> {
  //Invoke the second system interface nw.Clipboard.get( ).get of the NW.js
framework to implement a read operation
  return nw.Clipboard.get( ).get( ‘text’)
  }
```

The computer device adjusts, based on the above pseudocode fragment 7, a code related to readText in the first resource bundle, to obtain a writeText function suitable for the NW.js framework.

In some implementations, in addition to the differences in system interfaces related to the capability of reading from and writing to a system clipboard as described above, there are also differences in other system interfaces.

Following the above example, taking a function of opening a file location at a specified path in an operating system as an example, a function name of the function may be revealResourcesInOS. For this function, a first system interface provided by the first application development framework, for example, the Electron framework, is nativeHostService.showItemInFoler, and a second system interface provided by the second application development framework, for example, the NW framework, is nw.Shell.showItemInFoler. Therefore, a pseudocode for the revealResourcesInOS function in the first resource bundle is shown in the following pseudocode fragment 8:

```
  export function revealResourcesInOS(parameter): void {
      //Invoke the first system interface showItemInFolder of the Electron
framework to open a file
        nativeHostService.showItemInFolder(file location);
        ...
    }
```

For the first system interface showItemInFolder, according to the matching relationship shown in Table 1, it can be determined that a second system interface provided by the NW.js framework and matched with the first system interface is nw.Shell.showItemInFolder. The computer device adjusts a code fragment referencing showItemInFolder in the first resource bundle to a code fragment matched with nw. Shell.showItemInFolder. A pseudocode of the adjusted revealResourcesInOS is shown in the following pseudocode fragment 9:

```
  export function revealResourcesInOS(parameter)
  void {
        ...
    //Invoke the first system interface nw.Shell.showItemInFolder of the Electron
framework
nw.Shell.showItemInFolder(file location);
      ...
    }
```

The computer device adjusts, based on the above pseudocode fragment 9, a code related to revealResourcesInOS in the first resource bundle, to obtain a revealResourcesInOS function suitable for the NW.js framework.

Following the above example, taking a function of pulling up a file selection pop-up window as an example, a first system interface provided by the first application development framework, for example, the Electron framework, is a dialog.showSaveDialog method, and a second system interface provided by the second application development framework, for example, the NW framework, is nw.Shell.showItemInFoler. Therefore, a pseudocode for the revealResourcesInOS function in the first resource bundle is shown in the following pseudocode fragment 10:

```
async showSaveDialog(parameter) {
  ...
  result = await dialog.showSaveDialog(window, options);
  ... }
```

For the function of pulling up a file selection pop-up window, in the NW.js framework, it is converted to be supported by using an input tag and setting corresponding NW-specific attributes such as nwworkingdir and nwsaves. A corresponding pseudocode is shown in the following pseudocode fragment 11:

```
  export const saveFileDialog = (parameter): Promise<string>=> {
      input.setAttribute(“nwworkingdir”, directory)//nw -specific attribute such as
nwworkingdir
      input.setAttribute( ‘nwdirectory’,‘nwdirectory’)
      input.onchange = e => {//Add an event to the input }
      // Cancel the event for the input
      input.oncancel = e=> reject ({type:‘CANCFKL’/})
    }
```

The computer device adjusts, based on the above pseudocode fragment 11, resources related to the function of pulling up a file selection pop-up window in the first resource bundle, so that they are suitable for the NW.js framework.

In this aspect, an adjustment operation on resources of the second sub-communication type may include replacing a first system interface with a second system interface having a matching relationship therewith. In this way, by using a system interface as an adjustment unit, integrity of system interface adjustment can be improved, and resource adjustment efficiency can be improved. Adjustment based on a matching relationship between system interfaces can improve universality of the mode, and effectively adapt to scenarios of interconnecting between a plurality of different application development frameworks.

In some aspects, the computer device may perform the following operations on a second resource bundle suitable for the second application development framework: running by way of the second resource bundle, the application program directly in the second application development framework in the form of a desktop application; or invoking, by a target application program running in the second application development framework, the second resource bundle to run the application program in the target application program in the form of a plug-in.

In some implementations, the second resource bundle is obtained by adjusting a first resource bundle of an application program suitable for the first application development framework. The second resource bundle is suitable for the second application development framework. A mode of running the second resource bundle in the environment of the second application development framework may be directly running, in the environment of the second application development framework, the application program corresponding to the second resource bundle in the form of a desktop application. For example, the second resource bundle is used as an installation package to be directly installed and launched on the computer device. Alternatively, the second resource bundle may be integrated with other application programs that depend on the second application development framework. For example, the second resource bundle is used as a plug-in, and is invoked in a form of a plug-in in a target application program running in the second application development framework.

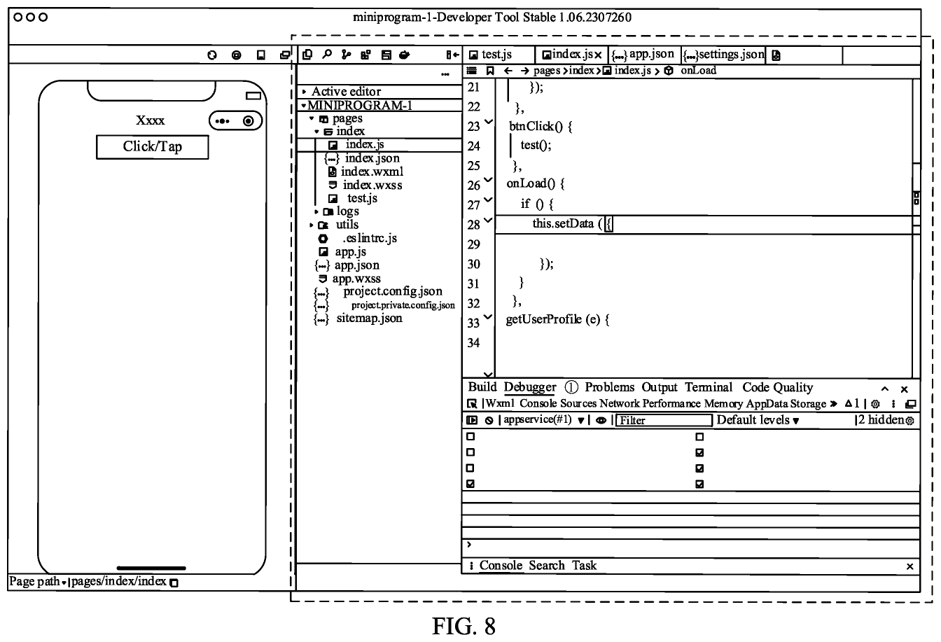

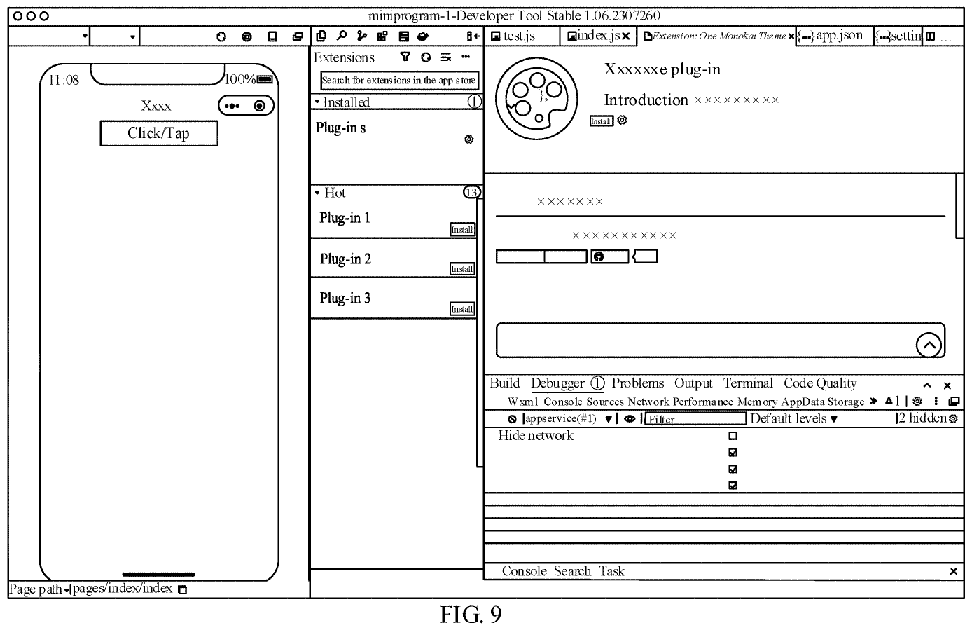

In an example, taking the first application development framework being an Electron framework, the second application development framework being an NW.js framework, and the application program depending on the first application development framework being vscode as an example, as shown in FIG. 8, an existing developer tool developed depending on the NW.js application development framework directly uses the adjusted second resource bundle of vscode, and performs, through the adjusted vscode, related operations on resources of an application program developed for the NW.js application development framework, such as viewing file content of a specified file as shown in the figure. As shown in FIG. 9, the adjusted vscode is encapsulated as a plug-in in an existing developer tool developed depending on the NW.js framework, so as to perform plug-in installation when needed, thereby using a capability of the adjusted vscode to operate a resource bundle of an application program developed depending on the NW.js framework.

In this aspect, there are multiple different modes of running the second resource bundle in an environment based on the second application development framework. In this way, application scenarios of the second resource bundle can be increased.

In some aspects, the application program developed based on the first application development framework includes a code editing application. The application program running by way of the second resource bundle is configured to edit resources of a subject application program executable under the second application development framework.

In some implementations, the application program developed based on the first application development framework may be a code editing application. Taking the first application development framework being an Electron framework as an example, the code editing application developed based on the Electron framework is vscode as mentioned above. To enable the code editing application to perform an editing operation on application resources of an application program developed based on the second application development framework, the computer device performs, on a first resource bundle of the code editing application, the application program processing method provided in this aspect of this disclosure, to obtain a second resource bundle corresponding to the code editing application. The second resource bundle can be suitable for the second application development framework, such as an NW.js framework.

In this aspect, through an adjustment operation on a code editing application developed depending on the first application development framework, a code editing application suitable for the second application development framework is obtained. This enables an application program depending on the second application development framework to integrate and use the code editing application. Thus, an editing function of a desktop application based on the second application development framework is satisfied, avoiding implementation through function degradation or consumption of self-development costs to align and implement a code editing application.

To describe the application program processing method in this solution, description will be given below with an non-limiting example. In one or more aspects, the first application development framework is an Electron framework, the second application development framework is an NW.js framework, and the application program developed depending on the first application development framework is the code editing tool vscode mentioned above. A specific application scenario is that a computer device adjusts vscode developed based on the Electron framework to obtain adjusted vscode suitable for the NW.js framework.

vscode is a code editor based on the Electron framework. Due to its strong dependency on the Electron framework, services using other underlying application development frameworks (such as NW.js, QT) may not directly use a powerful and general-purpose editor like vscode. Application programs of such other application development frameworks can usually use a web version of the vscode editor with fewer capabilities, or themselves implement and maintain a complex editor tool through a large amount of development work. However, using the web version editor with degraded functions not only has degraded functions, but also lacks a plug-in market and editing capabilities that rely more on system and file underlying capabilities. In addition, an editor may be developed based on the NW.js framework, but developing an editor is very cumbersome and complex, and the use experience thereof may not be aligned with that of the general-purpose vscode in the industry. Based on this, this disclosure provides an application program processing method for an application program vscode based on the Electron framework. The method can remove a dependency of vscode on the Electron framework, so that vscode can be compatible with and adapt to the NW.js framework. Additionally, vscode may also be adjusted based on application program resource conditions of other application development frameworks, to make vscode compatible with corresponding application development frameworks.

In some implementations, from the foregoing description, the Electron framework and the NW.js framework have similarities in technical implementation. In this disclosure, performing application program processing on vscode, which strongly depends on the Electron framework, may include adjusting, according to an application program resource condition matched with the NW.js framework, a resource bundle of vscode suitable for the Electron framework (for example, the first resource bundle mentioned above), so that an adjusted resource bundle of vscode (for example, the second resource bundle mentioned above) depending on the NW.js framework can be used. During an adjustment process of resources, differences between the Electron application development framework and the NW.js framework are resolved, such as differences in cross-process communication, differences in startup modes, differences in system capability interface invocation, and differences in file paths required by the. Thereby, the dependency of the first resource bundle of vscode on the Electron framework is removed, and a second resource bundle of vscode suitable for the NW.js framework is obtained. In this way, not only can cost investment of re-developing vscode suitable for the NW.js framework be avoided, but also a use experience of the adjusted vscode depending on the NW.js framework can be aligned with a use experience of vscode depending on the Electron framework before adjustment.

At a technical level, the application program processing method provided in this disclosure removes the dependency of vscode on the Electron framework in the following five aspects, to obtain adjusted vscode capable of being compatible with and adapting to the NW.js framework. The five aspects include: 1) removing unnecessary environment module codes; 2) resolving communication differences in system capability invocation; 3) resolving API interface differences of application development framework capabilities; 4) resolving dependency differences of vscode on the two application development frameworks; and 5) resolving differences in startup modes between different application development frameworks.

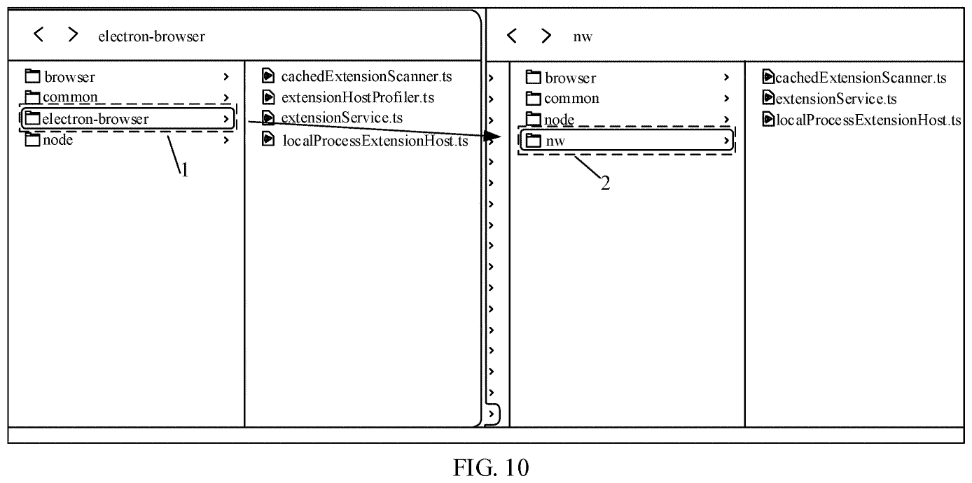

A specific implementation mode of removing unnecessary environment module codes is described. As shown in FIG. 7, vscode divides the entire function into five operating environment modules according to different operating environment modules. Each operating environment module may correspond to a folder. A common module includes common js methods. A browser module includes codes that use a browser application programming interface (API). A node module uses codes of a nodejs API. An electron-browser module is a code using an electron rendering thread and a browser API. An electron-main module is a code using an electron main process and a node.js API. However, as shown in FIG. 6, the electron-browser module and the electron-main module are not included in the NW.js framework. Therefore, the computer device may directly remove the electron-browser module and the electron-main module and codes associated with the modules, and add an operating environment module configured to the NW.js framework. In an example, as shown in FIG. 10, FIG. 10 is a diagram of an example of an adjustment mode of an operating environment module in an aspect. The electron-browser/extensionService in the electron-browser module, which is an operating environment module related to electron in vscode indicated by numeral 1 in FIG. 10, is removed. Meanwhile, an “nw/extensionService” operating environment module related to the NW.js framework indicated by numeral 2 in FIG. 10 is added.

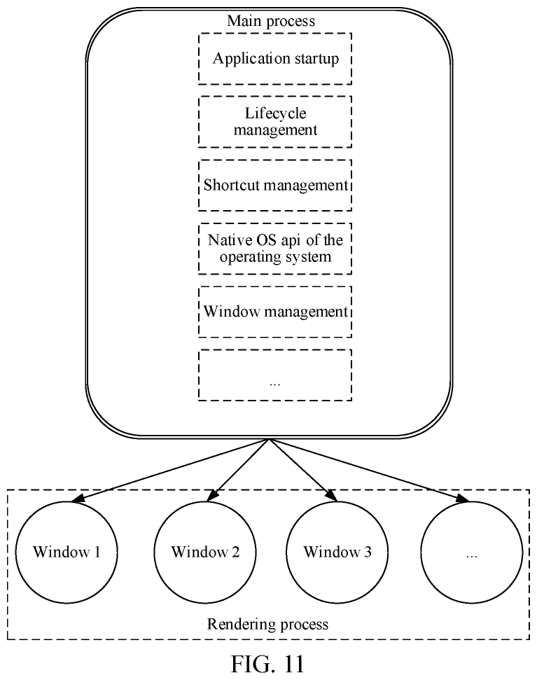

A implementation mode of resolving communication differences in system capability invocation will be described as a non-limiting example. According to the foregoing description, implementation principles of the electron framework and the nw.js framework are different. In the Electron desktop framework, cross-process communication exists when interacting with an operating system. To implement the cross-process communication, Electron implements a general communication module for implementing inter-process communication, which may be referred to as Inter-Process Communication (IPC), to be responsible for cross-process communication processing between a rendering process and a main process. As shown in FIG. 11, FIG. 11 is a structural diagram of an example of a general inter-process communication module in an aspect. What is shown in the figure is a structure of an IPC general communication module. There are differences in system capability invocation between the two application development frameworks. Therefore, the computer device can directly change, in vscode, a rendering process that invokes a main process service through an IPC channel to perform invocation separately in each process context. In an example, as shown in the foregoing pseudocode fragment 2, vscode based on the Electron framework obtains, through an instance MainProcessService, an IPC channel for cross-process communication with a main process, and then transmits a system interface command to the main process through the channel for invocation, so as to implement interaction with an operating system through the main process. When running in the NW.js application development framework, however, there is no need to depend on MainProcessService, and system capability invocation is directly performed in a process itself, as shown in the foregoing pseudocode fragment 3.

A specific implementation mode of resolving system interface differences of application development framework capabilities will be described. In some implementations, both the Electron and NW.js application development frameworks provide a plurality of APIs for interacting with an operating system (for example, the system interfaces mentioned above), for example, creating a system menu, a clipboard, file system processing, and the like. Since a desktop application running in the NW.js framework does not invoke a system interface supported by the Electron framework, the computer device converts a system interface supported by the Electron framework (for example, the first system interface mentioned above) into a system interface supported by the NW.js framework (for example, the second system interface mentioned above). During interface conversion, a system interface matching relationship as shown in Table 1 may be preset. The computer device adjusts, according to the system interface matching relationship, a first system interface supported by the Electron framework in vscode to a second system interface supported by the NW.js framework. Examples include system interface adjustment examples for using a capability of reading from and writing to a system clipboard shown in the foregoing pseudocode fragments 4 to 7, system interface adjustment examples for opening a file location at a specified path shown in the foregoing pseudocode fragments 8 and 9, and system interface adjustment examples for pulling up a file selection pop-up window shown in the foregoing pseudocode fragments 10 and 11.

A specific implementation mode of resolving dependency differences of vscode on the two application development frameworks will be described. In some implementations, vscode depends on some native components implemented based on a general-purpose programming language (such as C++). These native components are built by a node-gyp tool configured to the Electron application development framework to generate cross-platform binary files, such as vscode-ripgrep, vscode-oniguruma, vscode-textmate, vscode-fsevents, node-pty, spdlog, and the like. These compiled products are not directly applicable to the NW.js application development framework. The computer device invokes a compilation tool nw-gyp configured to the NW.js application development framework to recompile codes of the above compiled products. Specific compilation operations include: first, acquiring a source code of each native module; second, using the nw-gyp compilation tool to recompile the source code into a compiled product in a binary form required by the NW.js environment; and finally, replacing a compiled product in a binary form of a native module on which vscode depends and which is compiled based on node-gyp.

A specific implementation mode of resolving differences in startup modes between different application development frameworks will be described. In some implementations, an entry of an Electron application is a js file, while a startup entry of NW.js is html. Therefore, the computer device performs an adding operation, for example, adding a startup file in an html format as a startup entry, and loading a js file of a vscode editor in the startup file in the html format. A specific code modification process is shown in the foregoing pseudocode fragment 1.

In some implementations, after resolving the differences in the above five aspects, the computer device obtains adjusted vscode that can be compatible with and applicable to the NW.js application development framework. For example, the adjusted vscode may be used in the form of a plug-in in an application program depending on the NW.js application development framework. In an example, as shown in FIG. 8, an editing capability of adjusted vscode is directly used in an existing developer tool developed depending on the NW.js application development framework. As shown in FIG. 9, the adjusted vscode is encapsulated as a plug-in in an existing developer tool developed depending on the NW.js application development framework, so as to perform plug-in installation when needed, thereby using an editing capability of vscode.

By applying this aspect of this disclosure, an application program depending on the NW.js application development framework can integrate and use a vscode editor module. Thus, an editing function of a desktop application based on NW.js is satisfied, avoiding implementation through function degradation or consumption of self-development costs to align and implement an editor.

Although the operations in the flowcharts involved in the above aspects are sequentially displayed according to arrows, these operations are not necessarily performed in the order indicated by the arrows. Unless otherwise explicitly specified herein, execution of the operations is not strictly limited by the sequence, and these operations may be performed in other sequences. Moreover, at least part of the operations in the flowcharts involved in the aspects above may include multiple operations or multiple stages. These operations or stages are not necessarily executed at the same time, but may be executed at different times. These operations or stages are not necessarily performed sequentially, but may be performed in turn or alternately with other operations or at least part of operations or stages of other operations.

In a related aspect, this disclosure further provides an application program processing apparatus for implementing the application program processing method mentioned above. An implementation solution provided for the apparatus to solve the problem is similar to the implementation solution recorded in the above method. Therefore, for the specific limitations of one or more application program processing apparatus aspects provided below, a reference may be made to the limitations of the application program processing method mentioned above, which will not be repeated here.

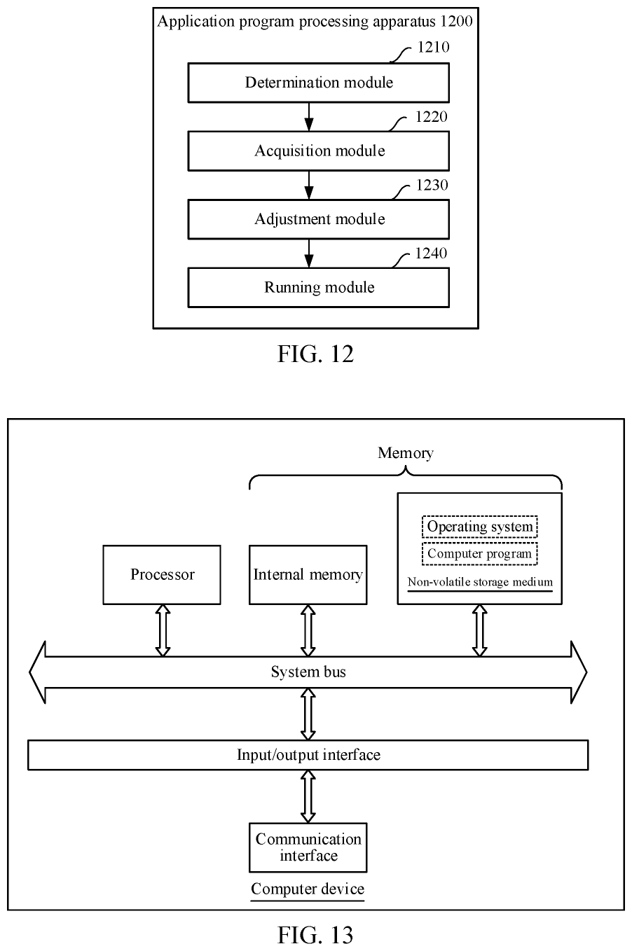

In some aspects, as shown in FIG. 12, an application program processing apparatus 1200 is provided, including: a determination module 1210, an acquisition module 1220, an adjustment module 1230, and a running module 1240.

The determination module 1210 is configured to determine a first application development framework, an application program, and a second application development framework.

The acquisition module 1220 is configured to acquire a first resource bundle of the application program. The first resource bundle is suitable for the first application development framework and includes application resources used by the application program during a use process thereof.

The adjustment module 1230 is configured to determine an application program resource condition matched with the second application development framework and adjust the first resource bundle according to the application program resource condition to obtain a second resource bundle of the application program. The second resource bundle is suitable for the second application development framework.

The running module 1240 is configured to run the application program in the second application development framework by way of the second resource bundle.

In some aspects, the application resources in the first resource bundle include at least one of: startup resources used by the application program during a startup phase thereof, operating environment resources used by the application program during an operating phase thereof, or communication resources used by the application program during the operating phase thereof.

In some aspects, the adjustment module is further configured to: determine resource types of the application resources used by the application program during a use process thereof; determine an application program resource condition matched with the second application development framework for each of the resource types; adjust, for any resource type, resources of the resource type in the first resource bundle according to the application program resource condition for the resource type to obtain adjusted resources; and determine a second resource bundle suitable for the second application development framework based on the adjusted resources of each resource type.

In some aspects, the resource types include a startup resource type. The adjustment module is further configured to: acquire a first startup file in the first resource bundle for a startup resource type, the first startup file corresponding to a first format; construct an initial startup file corresponding to a second format that is matched with the second application development framework according to the application program resource condition for the startup resource type; and reference the first startup file in the initial startup file to generate a target startup file suitable for the second application development framework, the target startup file being an adjusted resource.

In some aspects, the resource types include an environment resource type. The environment resource type includes a first sub-environment type and a second sub-environment type. The first sub-environment type is configured to indicate a folder of an operating environment of the application program. The second sub-environment type is configured to indicate a first compiled product used by the application program when running through the first application development framework. The first compiled product is implemented based on a general-purpose programming language. The adjustment module is further configured to: adjust, for the environment resource type, resources of the first sub-environment type in the first resource bundle, and adjust resources of the second sub-environment type in the first resource bundle according to an application program resource condition for the environment resource type; and determine adjusted resources of the environment resource type based on adjusted resources of the first sub-environment type and adjusted resources of the second sub-environment type.

In some aspects, the adjustment module is further configured to: determine a first folder related to an operating environment in the first resource bundle; determine a second folder matched with the second application development framework and related to the operating environment; and delete a folder related to the first application development framework from the first folder, and add the second folder to the first resource bundle.

In some aspects, the adjustment module is further configured to: determine a first compiled product in the first resource bundle; acquire a source code of the first compiled product, and recompile, by a compilation component corresponding to the second application development framework, the source code to generate a second compiled product configured to the second application development framework; and replace the first compiled product in the first resource bundle with the second compiled product.

In some aspects, the resource types include a communication resource type. The communication resource type includes a first sub-communication type and a second sub-communication type. The first sub-communication type is configured to indicate resources configured to perform cross-process communication. The second sub-communication type is configured to indicate resources configured to invoke system interfaces related to an operating system. The adjustment module is further configured to: adjust, for the communication resource type, resources of the first sub-communication type in the first resource bundle, and adjust resources of the second sub-communication type in the first resource bundle according to an application program resource condition for the communication resource type; and determine adjusted resources of the communication resource type based on adjusted resources of the first sub-communication type and adjusted resources of the second sub-communication type.

In some aspects, the adjustment module is further configured to: determine a code of a rendering process in which cross-process communication exists in the first resource bundle, the cross-process communication being configured to implement communication between the rendering process and an operating system; and adjust the code of the rendering process, so that a rendering process with the code adjusted directly implements communication through a context call (e.g., context invocation) when communicating with the operating system.

In some aspects, the adjustment module is further configured to: determine a first system interface invoked by the first resource bundle; determine, from system interfaces provided by the second application development framework, a second system interface having a function consistent with that of the first system interface; and adjust a code in the first resource bundle that invokes the first system interface based on the second system interface.

In some aspects, the running module is further configured to: run the application program directly in the second application development framework in a form of a desktop application by way of the second resource bundle; or invoke the second resource bundle by way of a target application program running in the second application development framework to run the application program in the target application program in a form of a plug-in.

In some aspects, the application program used by the application program processing apparatus includes a code editing application, and the application program running by way of the second resource bundle is configured to edit resources of a subject application program executable under the second application development framework.

The various modules in the application program processing apparatus above may be fully or partially implemented through software, hardware, or combinations thereof. The modules above may be embedded in hardware form or independent of a processor in a computer device, or stored in software form in a memory of the computer device, so that the processor can call and execute the operations corresponding to the modules above.

In an example aspect, a computer device is provided. The computer device may be a server or a terminal shown in FIG. 1, and an internal structural diagram thereof may be as shown in FIG. 13. The computer device includes a processor, a memory, an input/output (briefly referred to as I/O) interface, and a communication interface. The processor, the memory, and the input/output interface are connected to each other by using a system bus, and the communication interface is connected to the system bus by using the input/output interface. The processor of the computer device is configured to provide computing and control abilities. The memory of the computer device includes a non-volatile storage medium and an internal memory. The non-volatile storage medium stores an operating system, computer programs, and databases. The internal memory provides an environment for operation of the operating system and the computer program in the non-volatile storage medium. The database of the computer device is configured to store resource data of an application program. The input/output interface of the computer device is configured to exchange information between the processor and external devices. The communication interface of the computer device is configured to communicate with external terminals through a network connection. The computer program is executed by the processor to implement an application program processing method.

A person skilled in the art may understand that the structure shown in FIG. 13 is a block diagram of a partial structure related to a solution in this disclosure, and does not constitute a limitation to the computer device to which the solution in this disclosure is applied. The computer device may include more or fewer components than those shown in the figure, or some components may be combined, or a different component deployment may be adopted.

In some aspects, a computer device is provided, including a memory and a processor. The memory has a computer program stored therein. The processor executes the computer program to implement the operations in each method aspect described above.

In some aspects, a non-transitory computer-readable storage medium is provided, having a computer program stored therein. The computer program is executed by a processor to implement the operations in the foregoing method aspects.

In some aspects, a computer program product is provided, including a computer program. The computer program is executed by a processor to implement the operations in the foregoing method aspects.

The user information (including but not limited to user device information, user personal information, and the like) and data (including but not limited to data configured for analysis, stored data, displayed data, and the like) involved in this disclosure are information and data that have been authorized by the user or fully authorized by relevant parties, and the collection, use, and processing of related data comply with relevant regulations.

A person skilled in the art may understand that some or all of the processes of the method in the foregoing aspects may be implemented by a computer program instructing relevant hardware. The computer program may be stored in a non-transitory computer-readable storage medium. When the computer program is executed, the processes of the foregoing method aspects may be implemented. Any reference to the memory, the database, or other mediums used in the aspects provided in this disclosure may include at least one of non-volatile or volatile memories. The non-volatile memory may include a Read Only Memory (ROM), a magnetic tape, floppy disk, a flash memory, an optical memory, a high-density embedded non-volatile memory, a Resistive Random Access Memory (ReRAM), a Magnetoresistive Random Access Memory (MRAM), a Ferroelectric Random Access Memory (FRAM), a Phase Change Memory (PCM), a graphene memory, or the like. The volatile memory may include a random-access memory (RAM) or an external cache. As an explanation rather than limitation, the RAM may be in various forms, such as Static Random Access Memory (SRAM) or Dynamic Random Access Memory (DRAM). The databases involved in the various aspects provided in this disclosure may include at least one of a relational database or a non-relational database. The non-relational database may include a blockchain-based distributed database or the like, which is not limited here. The processor involved in the various aspects provided in this disclosure may be a general-purpose processor, a central processing unit, a graphic processing unit, a digital signal processor, a programmable logic unit, a quantum computing-based data processing logic unit, or the like, which is not limited here.

Technical features of the foregoing aspects may be combined in various manners to form other aspects. To make description concise, not all possible combinations of the technical features in the foregoing aspects are described. However, the combinations of these technical features shall be considered as falling within the scope recorded by this specification provided that no conflict exists.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing aspects describe several implementations of this disclosure, which shall not be construed as a limitation to the present disclosure. A person skilled in the art may make several variations and improvements without departing from the concept of this disclosure, which, however, still fall within the scope of this disclosure.

What is claimed is:

1. An application program execution method, comprising:
determining a first application development framework, an application program, and a second application development framework based on a user operation;
obtaining a first resource bundle of the application program, the first resource bundle indicating first application resources usable by the application program executed under the first application development framework;
adjusting the first resource bundle based on application program resource condition information of the second application development framework to obtain a second resource bundle of the application program, the second resource bundle indicating second application resources usable by the application program executed under the second application development framework; and
executing, by processing circuitry, the application program under the second application development framework based on the second resource bundle.

2. The method according to claim 1, wherein the first application resources in the first resource bundle include at least one of:
startup resources usable during a startup phase of execution of the application program,
operating environment resources usable during an operating phase of the execution of the application program, or
communication resources usable during the operating phase of the execution of the application program.

3. The method according to claim 1, wherein
the application program resource condition information includes:
for each of a plurality of resource types of the first application resources, a respective application program resource condition of the second application development framework, and
the adjusting the first resource bundle includes:
adjusting, for each of the resource types, resources of the respective resource type in the first resource bundle into corresponding adjusted resources of the respective resource type in the second resource bundle based on the corresponding application program resource condition for the respective resource type.

4. The method according to claim 3, wherein
the resource types include a startup resource type, and
the adjusting, for each of the resource types, the resources of the respective resource type includes:
acquiring a first startup file in the first resource bundle for the startup resource type, the first startup file corresponding to a first format;
constructing an initial startup file corresponding to a second format that complies with the second application development framework based on the corresponding application program resource condition for the startup resource type; and
modifying the initial startup file, based on referencing the first startup file in the initial startup file, into a second startup file in the second resource bundle for the second application development framework.

5. The method according to claim 3, wherein
the resource types include an environment resource type that includes a first sub-environment type and a second sub-environment type,
the first sub-environment type indicates a folder of an operating environment of the application program,
the second sub-environment type indicates a first compiled product usable by the application program executed under the first application development framework, and the first compiled product is based on a source code in a programming language.

6. The method according to claim 5, wherein the adjusting, for each of the resource types, the resources of the respective resource type comprises:
adjusting resources of the first sub-environment type in the first resource bundle and resources of the second sub-environment type in the first resource bundle based on the corresponding application program resource condition for the environment resource type.

7. The method according to claim 6, wherein the adjusting the resources of the first sub-environment type in the first resource bundle comprises:
determining a first folder related to an operating environment in the first resource bundle;
determining a second folder that complies with the second application development framework and related to the operating environment;
deleting, from the first folder, one or more folders related to the first application development framework from the first folder; and
adding the second folder to the first resource bundle.

8. The method according to claim 6, wherein the adjusting the resources of the second sub-environment type in the first resource bundle comprises:
acquiring the source code of the first compiled product;
recompiling, by a compilation component corresponding to the second application development framework, the source code into a second compiled product usable by the application program executed under the second application development framework; and
replacing the first compiled product in the first resource bundle with the second compiled product.

9. The method according to claim 3, wherein
the resource types include a communication resource type that includes a first sub-communication type and a second sub-communication type,
the first sub-communication type indicates resources for performing cross-process communication, and the second sub-communication type indicates resources for invoking one or more system interfaces related to an operating system.

10. The method according to claim 9, wherein the adjusting, for each of the resource types, the resources of the respective resource type comprises:
adjusting resources of the first sub-communication type in the first resource bundle and resources of the second sub-communication type in the first resource bundle based on the corresponding application program resource condition for the communication resource type.

11. The method according to claim 10, wherein the adjusting the resources of the first sub-communication type in the first resource bundle comprises:
determining that the first resource bundle includes a code of a rendering process in which cross-process communication is incorporated, the cross-process communication corresponding to implementing communication between the rendering process and the operating system; and
adjusting the code of the rendering process based on implementing the communication between the rendering process and the operating system through context invocation instead of the cross-process communication.

12. The method according to claim 10, wherein the adjusting the resources of the second sub-communication type in the first resource bundle comprises:
determining a first system interface invocable by the first resource bundle;
determining, from available system interfaces under the second application development framework, a second system interface having a function consistent with that of the first system interface; and
adjusting a code in the first resource bundle that invokes the first system interface based on the second system interface.

13. The method according to claim 1, wherein the executing the application program under the second application development framework comprises:
executing the application program as a desktop application directly under the second application development framework based on the second resource bundle.

14. The method according to claim 1, wherein the executing the application program under the second application development framework comprises:
invoking the second resource bundle in a form of a plug-in through a target application program executed under the second application development framework.

15. The method according to claim 1, wherein
the application program corresponds to a code editing application, and
the executing the application program under the second application development framework based on the second resource bundle corresponds to editing resources of a subject application program executable under the second application development framework.

16. An application program execution apparatus, comprising:
processing circuitry configured to:
determine a first application development framework, an application program, and a second application development framework based on a user operation;
obtain a first resource bundle of the application program, the first resource bundle indicating first application resources usable by the application program executed under the first application development framework;
adjust the first resource bundle based on application program resource condition information of the second application development framework to obtain a second resource bundle of the application program, the second resource bundle indicating second application resources usable by the application program executed under the second application development framework; and
execute the application program under the second application development framework based on the second resource bundle.

17. The application program execution apparatus according to claim 16, wherein the first application resources in the first resource bundle include at least one of:
startup resources usable during a startup phase of execution of the application program,
operating environment resources usable during an operating phase of the execution of the application program, or
communication resources usable during the operating phase of the execution of the application program.

18. The application program execution apparatus according to claim 16, wherein
the application program resource condition information includes:
for each of a plurality of resource types of the first application resources, a respective application program resource condition of the second application development framework, and
the processing circuitry is configured to:
adjust, for each of the resource types, resources of the respective resource type in the first resource bundle into corresponding adjusted resources of the respective resource type in the second resource bundle based on the corresponding application program resource condition for the respective resource type.

19. The application program execution apparatus according to claim 16, wherein the processing circuitry is configured to:
execute the application program as a desktop application by executing the application program directly under the second application development framework based on the second resource bundle; or
execute the application program as a plug-in by invoking the second resource bundle through a target application program executed under the second application development framework.

20. A non-transitory computer-readable storage medium storing instructions, which when executed by a processor, cause the processor to perform an application program execution method comprising:
determining a first application development framework, an application program, and a second application development framework based on a user operation;
obtaining a first resource bundle of the application program, the first resource bundle indicating first application resources usable by the application program executed under the first application development framework;
adjusting the first resource bundle based on application program resource condition information of the second application development framework to obtain a second resource bundle of the application program, the second resource bundle indicating second application resources usable by the application program executed under the second application development framework; and
executing the application program under the second application development framework based on the second resource bundle.
